(19) United States
(12) Patent Application Publication
(10) Pub. No.: US 2011/0055683 A1
(43) Pub. Date: Mar. 3, 2011

(54) PAGE CACHING FOR RENDERING DYNAMIC WEB PAGES

(75) Inventor: Changhao Jiang, San Jose, CA (US)

(73) Assignee: FACEBOOK INC., Palo Alto, CA (US)

(21) Appl. No.: 12/553,074

(22) Filed: Sep. 2, 2009

(51) Int. Cl. G06F 3/048; G06F 15/16; G06F 17/21

(52) U.S. Cl. 715/234; 709/219; 715/760

(57) ABSTRACT

In one embodiment, a method includes, in response to a determination that one or more resources related to a requested target structured document are stored in a cache: accessing, by a first executable code segment embedded in a rendered structured document and executing within the context of a first client application, one or more resources related to the target structured document in the cache; calling, by the first executable code segment, one or more handler functions associated with corresponding resources of the target structured document, each handler function operative to transmit requests to a remote server for updates to a respective resource; and rendering, by the first executable code segment, content rendered by the first client application based at least in part on the one or more accessed resources in the cache and the updates retrieved by the one or more handler functions.

### TECHNICAL FIELD

The present disclosure relates generally to rendering structured documents (such as web pages) and, more particularly, to efficiently rendering structured documents using cached resources in conjunction with asynchronous techniques for retrieving incremental updates to the structured documents.

### BACKGROUND

Conventionally, when a user viewing web content at a remote client desires to navigate to a new (or “target”) web page from the currently rendered web page (e.g., by clicking on a link within the currently rendered web page, by clicking the back or forward button of a browser application, or by entering the URL of the target web page), the browser responsible for rendering the web content formulates a request for the new web page and transmits the request to a server hosting the new web page. Thus, conventionally, each time a user requests to navigate to a new web page, the browser transmits a request to the server for the full new web page, unloads the currently rendered page, and renders the new web page received from the server in its entirety. Conventionally, this full page loading and unloading scheme would hold true for each subsequent page the user requests. The web page and certain resources embedded in the underlying web page may be located in a browser cache and retrieved locally. However, many dynamic or interactive web pages include content and other resources that may be changed or updated frequently since they were last rendered. Conventionally, if any portion of a cached page is changed, the entire cached page is invalidated and emptied from the cache.

### BRIEF DESCRIPTION OF THE DRAWINGS

FIG. 1 illustrates an example network environment.

FIG. 2 illustrates an example block diagram showing interaction among various elements of an example network environment.

FIG. 3 illustrates an example process for initializing a page rendering process.

FIGS. 4A and 4B illustrate example processes for rendering a target web page.

FIG. 5 illustrates an example process for initializing a page rendering process.

FIG. 6 illustrates an example process for rendering a target web page.

FIG. 7 illustrates an example computer system architecture.

### DESCRIPTION OF EXAMPLE EMBODIMENTS

Particular embodiments relate to efficiently rendering web pages and other structured documents using cached resources in conjunction with asynchronous techniques for retrieving updates to the cached resources from remote and/or local data stores. Particular embodiments further relate to systems, methods, and logic for rendering a web page or other structured document that reduces or eliminates the browser overhead associated with reloading content (whether accessed remotely from a server and/or locally from a cache) and re-executing scripts that were downloaded in connection with one or more previously rendered web pages. Particular embodiments utilize Asynchronous JavaScript and XML (AJAX) techniques to request only the new content and resources that are necessary to render the target web page without causing a browser or underlying client application to unnecessarily naively re-render the entire web page. Particular embodiments relate to a downloadable process that executes within the context of a browser and that intercepts requests from the browser for a web page, accesses one or more cached resources, and transmits requests for incremental updates to the one or more cached resources to render the web page in an updated form. In various example embodiments, one or more described web pages may be associated with a social networking system or social networking service executing within a web site. However, embodiments of the invention have application to the retrieval and rendering of structured documents hosted by any type of network addressable resource or web site. As used herein, a “user” may be an individual, a group, or an entity (such as a business or third party application).

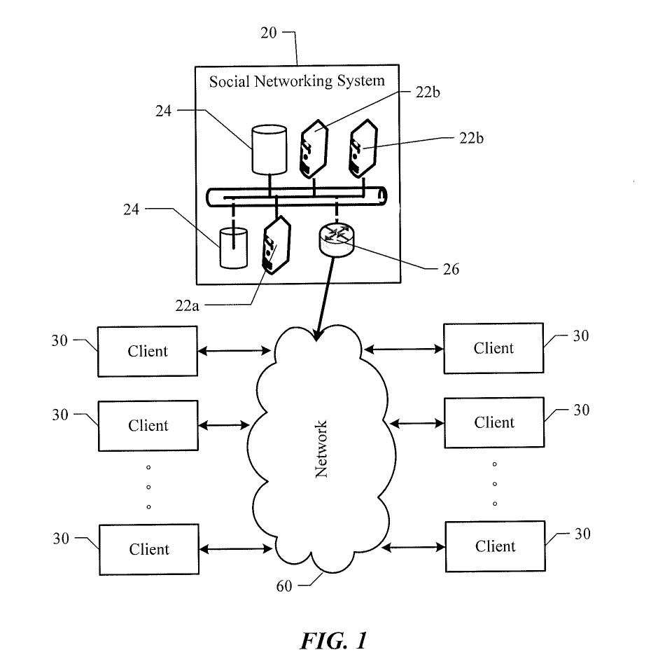

Particular embodiments of the invention may operate in a wide area network environment, such as the Internet, including multiple network addressable systems. FIG. 1 illustrates an example network environment, in which various example embodiments may operate. Network cloud 60 generally represents one or more interconnected networks, over which the systems and hosts described herein can communicate. Network cloud 60 may include packet-based wide area networks (such as the Internet), private networks, wireless networks, satellite networks, cellular networks, paging networks, and the like. As FIG. 1 illustrates, particular embodiments may operate in a network environment comprising social networking system 20 and one or more client devices 30. Client devices 30 are operably connected to the network environment via a network service provider, a wireless carrier, or any other suitable means.

The social networking system 20 comprises computing systems that allow users to communicate or otherwise interact with each other and access content, such as user profiles, as described herein. Social networking system 20 is a network addressable system that, in various example embodiments, comprises one or more physical servers 22 and data store 24. The one or more physical servers 22 are operably connected to computer network 60 via, by way of example, a set of routers and/or networking switches 26. In an example embodiment, the functionality hosted by the one or more physical servers 22 may include web or HTTP servers, FTP servers, as well as, without limitation, webpage and applications implemented using Common Gateway Interface script (CGI), PHP Hyper-text Preprocessor (PHP), Active Server Pages (ASP), Hyper Text Markup Language (HTML), Extensible Markup Language (XML), Java, JavaScript, AJAX, and the like.

Physical servers 22 may host functionality directed to the operations of a social networking system. By way of example, social networking system 20 may host a website that allows one or more users, at one or more client devices 30, to view and post information, as well as communicate with one another via the website. Hereinafter servers 22 may be referred to as server 22, although server 22 may include numerous servers hosting, for example, social networking system 20, as well as other content distribution servers, data stores, and databases. Data store 24 may store content and data relating to, and enabling, operation of the social networking system as digital data objects. A data object, in particular implementations, is an item of digital information typically stored or embodied in a data file, database or record. Content objects may take many forms, including: text (e.g., ASCII, SGML, HTML), images (e.g., jpeg, tif and gif), graphics (vector-based or bitmap), audio, video (e.g., mpeg), or other multimedia, and combinations thereof. Content object data may also include executable code objects (e.g., games executable within a browser window or frame), podcasts, etc. Logically, data store 24 corresponds to one or more of a variety of separate and integrated databases, such as relational databases and object-oriented databases, that maintain information as an integrated collection of logically related records or files stored on one or more physical systems. Structurally, data store 24 may generally include one or more of a large class of data storage and management systems. In particular embodiments, data store 24 may be implemented by any suitable physical system(s) including components, such as one or more database servers, mass storage media, media library systems, storage area networks, data storage clouds, and the like. In one example embodiment, data store 24 includes one or more servers, databases (e.g., MySQL), and/or data warehouses (e.g., Hadoop/Hive).

Data store 24 may include data associated with different social networking system 20 users and/or client devices 30. In particular embodiments, the social networking system 20 maintains a user profile for each user of the system 20. User profiles include data that describe the users of a social network, which may include, for example, proper names (first, middle and last of a person, a tradename and/or company name of a business entity, etc.) biographic, demographic, and other types of descriptive information, such as work experience, educational history, hobbies or preferences, geographic location, and additional descriptive data. By way of example, user profiles may include a user's birthday, relationship status, city of residence, and the like. The system 20 may further store data describing one or more relationships between different users. The relationship information may indicate users who have similar or common work experience, group memberships, hobbies, or educational history. A user profile may also include privacy settings governing access to the user's information.

Client device 30 is generally a computer or computing device including functionality for communicating (e.g., remotely) over a computer network. Client device 30 may be a desktop computer, laptop computer, personal digital assistant (PDA), in- or out-of-car navigation system, smart phone or other cellular or mobile phone, or mobile gaming device, among other suitable computing devices. Client device 30 may execute one or more client applications, such as a web browser (e.g., Microsoft Windows Internet Explorer, Mozilla Firefox, Apple Safari, Google Chrome, and Opera, etc.), to access and view content over a computer network. In particular implementations, the client applications allow a user of client device 30 to enter addresses of specific network resources to be retrieved, such as resources hosted by social networking system 20. These addresses can be Uniform Resource Locators (URLs). In addition, once a page or other resource has been retrieved, the client applications may provide access to other pages or records when the user “clicks” on hyperlinks to other resources. By way of example, such hyperlinks may be located within the web pages and provide an automated way for the user to enter the URL of another page and to retrieve that page.

Generally, a web application is an application that may be accessed via a web browser or other client application over a network, or a computer software application that is coded in a web browser-supported language and reliant on a web browser to render the application executable. Web applications have gained popularity largely as a result of the ubiquity of web browsers, the convenience of using a web browser launched at a remote computing device as a client (sometimes referred to as a thin client), and the corresponding ability to update and maintain web applications without distributing and installing software on remote clients. Often, to implement a web application, the web application requires access to one or more resources provided at a backend server of an associated website. Additionally, web applications often require access to additional resources associated with other applications.

A resource or page, which may itself include multiple embedded resources, may include data records, such as content plain textual information, or more complex digitally encoded multimedia content, such as software programs or other code objects, graphics, images, audio signals, videos, and so forth. One prevalent markup language for creating web pages is the Hypertext Markup Language (HTML). Other common web browser-supported languages and technologies include the Extensible Markup Language (XML), the Extensible Hypertext Markup Language (XHTML), JavaScript, Cascading Style Sheet (CSS), and, frequently, Java. By way of example, HTML enables a page developer to create a structured document by denoting structural semantics for text and links, as well as images, web applications and other objects that can be embedded within the page. Generally, a web page may be delivered to a client as a static document, however, through the use of web elements embedded in the page, an interactive experience may be achieved with the page or a sequence of pages. During a user session at the client, the web browser interprets and displays the pages and associated resources received or retrieved from the website hosting the page, as well as, potentially, resources from other websites.

JavaScript is an example of a scripting language that enables various web applications to access resources within other applications for use on the client side of a user session to enable an interactive or dynamic user session when accessing a website. AJAX (shorthand for Asynchronous JavaScript and XML) refers to a group of interrelated techniques used on the client side of a user session to enable more interactive and rich internet applications. Utilizing JavaScript or AJAX, a web application can transmit requests for resources to the backend servers (e.g., servers 22) of the website or other resource providers external to the website in order to retrieve the resources asynchronously in the background operations of the client 30 without interfering with the display and behavior of the currently-rendered page. More particularly, when using AJAX, resources are usually retrieved by transmitting an XMLHttpRequest (XHR) object to the resource provider. An XHR is a document object model (DOM) application programming interface (API) that can be used with a web browser scripting language (e.g., JavaScript) to send, for example, an HTTP or HTTPS request for a resource directly to a web server (e.g., server 22) and load the resource retrieved from the server in response to the request directly back into the scripting language code. Once the resource is within the code, the resource may then be available as, by way of example, an HTML or XML document or plain text. In this manner, the retrieved resource may be used to manipulate the currently active document rendered by the web browser without requiring the client to load a new webpage document. In some example embodiments, if the resource is retrieved as plain text, the plain text may be formatted in JavaScript Object Notation (JSON) by the server and evaluated within JavaScript to create an object of data for use on the current DOM.

Social networking system 20 may include a multitude of features with which users at remote clients 30 may interact during user sessions. In particular embodiments, these features may be implemented as web applications and may utilize JavaScript and Cascading Style Sheet (CSS) resources requested from servers 22 as well as other external servers. The web applications or resources may be embedded in various underlying or base web pages served to remote clients, such as in frames or iFrames, pagelets, sections or “divs” and the like. By way of example, the social networking system hosted by Facebook(r), Inc. of Palo Alto, Calif., includes or supports such features as the “wall,” a space on every user's profile page that allows friends to post messages for the user to see; “pokes,” which allows users to send a virtual “poke” to each other (a notification that tells a user that they have been poked); “photos,” where users can upload albums and photos; “status,” which allows users to inform their friends of their whereabouts and actions; “streams,” which may appear in multiple locations on the site, including on every user's homepage, which include information about the activities of the user's connections; “notes,” a blogging feature that allows tags and embeddable images as well as blogs imported from other blogging websites and services; as well as a large number of third party applications for which the website serves as a platform. In particular, a user's wall is visible to anyone who is able to see that user's profile, depending on privacy settings, and supports the posting of attachments as well as textual content.

In particular embodiments, the social networking system 20 maintains in data store 24 a number of objects for the different kinds of items with which a user may interact while accessing system 20. In one example embodiment, these objects include user profiles, application objects, and message objects (such as for wall posts, emails and other messages). In one embodiment, an object is stored by the system 20 for each instance of its associated item. These objects and the actions discussed herein are provided for illustration purposes only, and it can be appreciated that an unlimited number of variations and features can be provided on a social networking system 20.

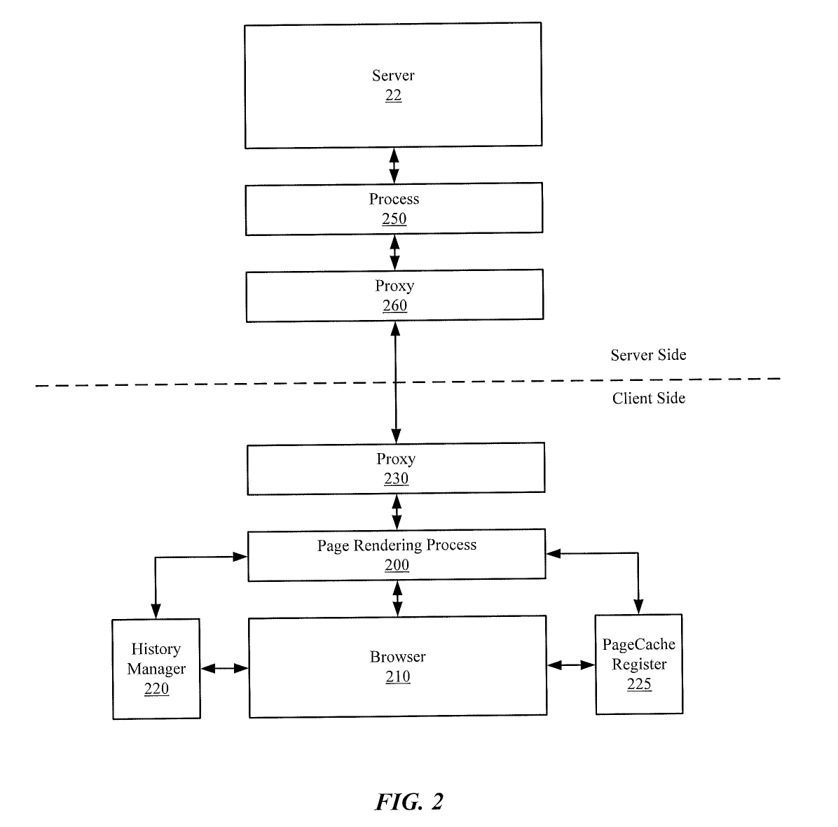

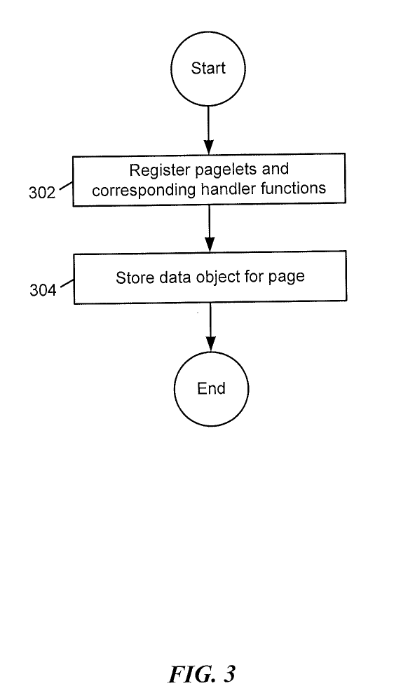

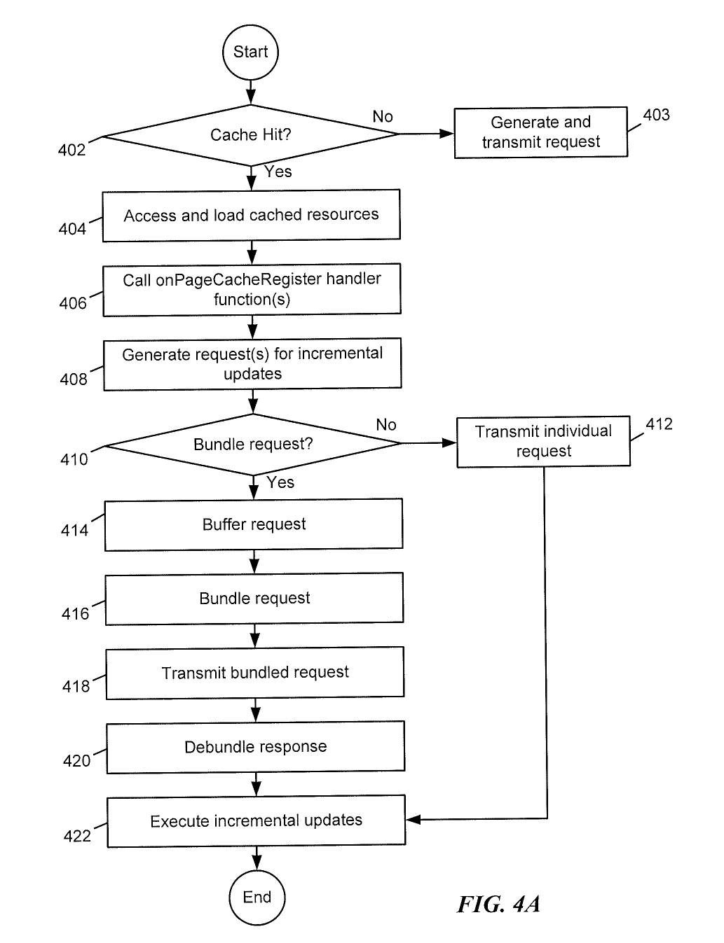

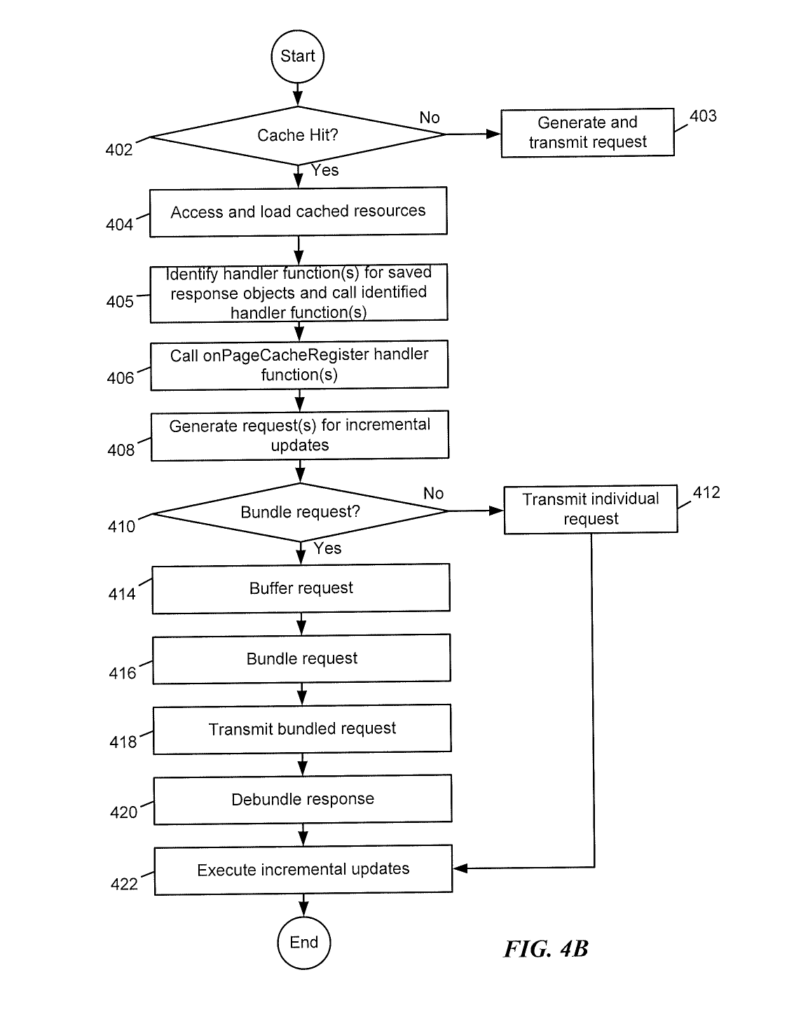

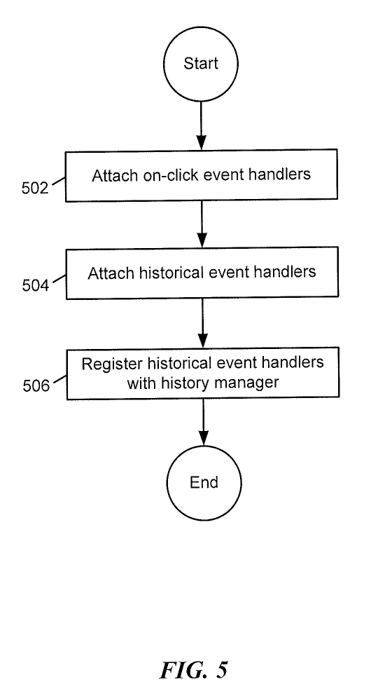

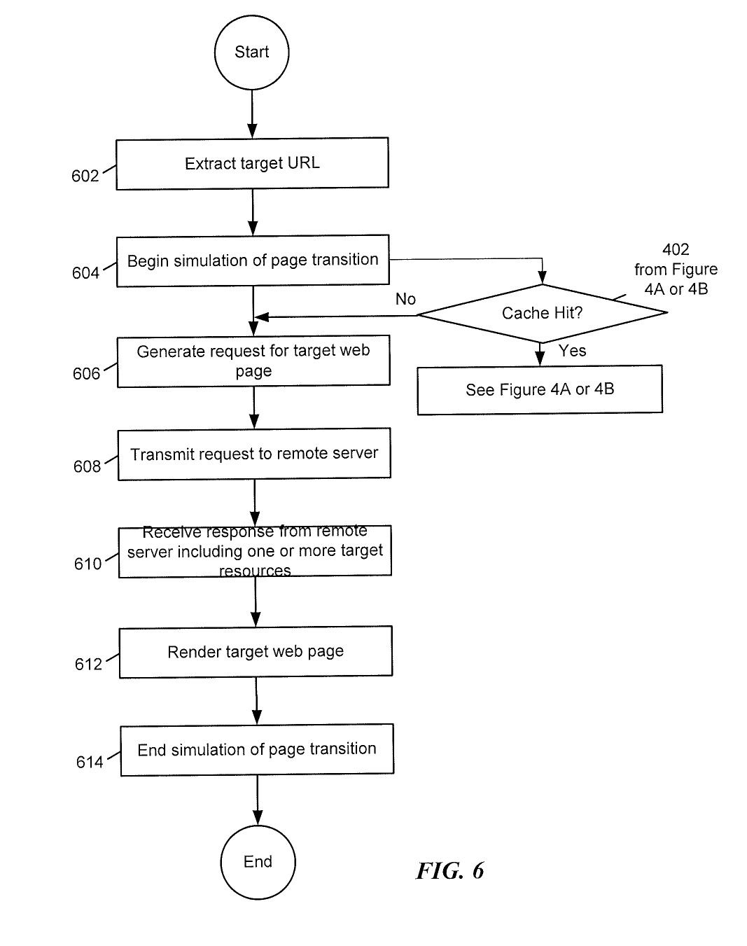

An example page rendering application or process 200 that facilitates the downloading and rendering of a web page will now be described initially with reference to the block diagram of FIG. 2 and the flowcharts of FIGS. 3 and 4. In particular embodiments, page rendering process 200 may be considered a client application that executes within the context of a web browser 210 executing at a client 30. In one implementation, page rendering process 200 is implemented as one or more executable code segments or script modules (such as JavaScript modules) that are embedded in an underlying web page loaded into web browser 210 with a currently rendered page. More specifically, when a user desires to view a web page of, for example, system 20 hosted by server 22, the user indicates this desire to browser 210 (e.g., by typing in the URL of the web page, by clicking on a bookmark for the web page, or by clicking a textual link or other embedded link to the web page, among other means) executing on the user's host computer (e.g., client 30). Browser 210, executing within client 30, then conventionally sends a request to the server 22 hosting the web page. In response to the request, and perhaps after user/client authentication, the server 22 retrieves and transmits to client 30 content, executable scripts, and/or other resources enabling browser 210 to render the web page in a client window displayed via client 30. By way of example, these and other resources retrieved by server 22 may be found at server 22, in data store 24, or in any other suitable server or database accessible by server 22 (hereinafter collectively referred to as server 22). As described above, the retrieved content may be HTML, XHTML, or XML content, for example, while the scripts may be JavaScript scripts or CSS files, among others, for example. The content and/or other resources may also include plain text and/or JSON encoded data structures, image, audio, and video files, as well as links (e.g., hypertext links) or calls to other resources or pages including URLs of those target resources or pages.

In particular embodiments, server 22 further transmits, with or within the response, executable code or scripts downloadable by browser 210 executing on client 30 for implementing page rendering process 200 within browser 210. By way of example, page rendering process 200 may be embedded as a script or call within the content or other resources transmitted in the response for the target page from server 22, and executes in the context of browser 210. In particular embodiments, the response further includes one or more libraries downloadable by browser 210 for use by page rendering process 200. Generally, each library may include code, data, subroutines or classes for use by page rendering process 200. For example, history manager 220 is an example of a JavaScript module and library that page rendering process 200 may access as described more fully below. In particular embodiments, every time a user, via browser 210 or other application executing on a host client 30, first requests a page or resource from a particular site or server (e.g., server 22) during a new user session with the site or server, the response to the request includes the executable code, scripts, and libraries for implementing page rendering process 200 at the client.

In particular embodiments, after browser 210 downloads the web page, the embedded call for implementing page rendering process 200 automatically calls an initialization function of the process 200 thereby automatically commencing execution of page rendering process 200. In particular embodiments, page rendering process 200 may be considered a software abstraction layer between browser 210 and server 22. The behavior of page rendering process 200 may vary depending on various factors such as the particular browser the page rendering process 200 is executing within.

In various example embodiments, a web page or other structured documents may be structured as one or more frames, logical or visual sections, executable modules, and/or other subdivisions, hereinafter collectively referred to as “pagelets.” By way of example, each pagelet may include a web application or feature to be executed and/or rendered by browser 210. In particular embodiments, each web application developed for a corresponding pagelet includes resources such as HTML content and JavaScript files for implementing the corresponding web application. Referring to the flowchart of FIG. 3, in particular embodiments, each web application includes a script that, upon downloading by browser 210, calls page rendering process 200 and registers with page rendering process 200 at 302. In particular embodiments, each web application further includes a corresponding handler function that is registered with page rendering process 200 at 302. More specifically, page rendering process 200 may include an application programming interface (API) referred to herein as PageCacheRegister 225 that enables web applications embedded in a web page to register respective handler functions with rendering process 200. The handler function is an executable code segment that is called by the page rendering process when the underlying page, once cached, is re-executed by the browser 210, such as when a target page is requested (a “cache hit”). The handler function may further specify how page rendering process 200 should respond to a cache hit. By way of example, in the event that a user navigates to a previously rendered page having corresponding resources that have been cached or stored in a cache by browser 210 for use in rendering a pagelet (a “cache hit”), the handler function may access a remote server to request updates to cached resources or even new resources for rendering the pagelet within the target page.

To facilitate registration and subsequent use, page rendering process 200 is configured to generate and store a data object for the web page at 304 that maps the URL of the rendered page with the handler functions corresponding to the pagelets within that page. The data object may also include all or a portion of the response received from server 22 hosting the resources required for rendering the web page. In particular embodiments, page rendering process 200 further stores a timestamp within the corresponding data object that indicates when the corresponding requests for resources for the target page were transmitted to the servers, when the response or responses were received from the servers, and/or when the resources were rendered by browser 210 at the client 30.

Generally, browser 210 will cache (e.g., within temporary memory at client 30) the resources downloaded for a rendered web page so that one or more of these resources may be utilized when a user navigates away from a currently rendered web page to another web page or pages and then desires to return to a previously rendered web page. By way of example, referring to FIG. 4A, when a user desires to navigate to a web page from the currently rendered web page (e.g., by clicking on a textual link or a link embedded within a page element such as a picture or user profile icon within the currently rendered web page, by clicking the back or forward button, or by typing or otherwise entering the URL of the target web page), before any requests for resources are sent to corresponding servers 22, browser 210 (or, as explained below in connection with an alternative embodiment, page rendering process 200 itself intercepts the request) may first determine at 402 if there is a cache hit; that is, if the target web page was previously rendered by browser 210 and stored in the cache by comparing the URL of the target web page with the URLs in the data structure corresponding to previously rendered and cached web pages. In an example embodiment, if there is not a cache hit, browser 210 constructs and generates a request for the web page or other target resource. In other embodiments, page rendering process 200 intercepts the request (as discussed in more detail below) and instructs or enables browser 210 to generate and transmit a request at 403 for resources in order to render the target page. In various embodiments, the request sent at 403 may be a conventional request or an AJAX or other asynchronous request as described more fully below with reference to FIGS. 5 and 6.

However, in the case of a cache hit at 402, browser 210 (or, in other embodiments, page rendering process 200) accesses and loads the cached resources corresponding to the previously rendered target web page at 404 for execution and rendering by browser 210. By way of example, the cached resources may include HTML content as well as JavaScript or CSS files that may then be reloaded or re-executed, respectively, such as an instance of the page rendering process 200 itself). As FIG. 4A illustrates, page rendering process 200 at 406 calls the handler functions corresponding to the pagelets within the page that previously registered with the page rendering process at the time when the underlying page was previously executed and rendered by browser. As discussed above, page rendering process 200 may access the data object created for the web page that maps the URL of the rendered page with the handler functions that were previously registered. Each handler function (in one embodiment, segments of JavaScript or other executable code) may then generate its own request for resources at 408 for transmission to the server 22 hosting the requested resources utilizing, by way of example and not by way of limitation, AJAX and/or other asynchronous techniques including those described below with reference to FIGS. 5 and 6. By way of example, the request may be a request for incremental updates for resources required by the corresponding application that have changed since the page, and more particularly the pagelet, was last rendered by browser 210. In particular embodiments, each handler functions includes the corresponding timestamp for the resources required for rendering the corresponding application within the request. In particular embodiments, server 22 includes an application or process 250 that receives requests from the handler functions and determines whether there have been any updates to the corresponding resources since the resources were last transmitted to the client 30 and rendered based on the corresponding timestamps. To facilitate communication between client 30 and server 22, and further reduce latency, client 30 and server 22 may maintain one or more persistent transport layer connections enabling client 30 and server 22 to send and receive multiple HTTP or secure HTTP (HTTPS) requests using the same Transmission Control Protocol (TCP) connection.

In some particular embodiments, a proxy application or process 230, which also may be implemented as JavaScript or any other executable code, is also downloaded with page rendering process 200 in response to a request for a web page. By way of example, proxy 230 may be download in the form of a library or other executable code segment coded in JavaScript. As the target web page may generally include multiple pagelets and corresponding handler functions each of which may generate a request for new or updated resources, in order to more efficiently request these resources, e.g., reduce the amount of bandwidth required to serve all of the requests and reduce latency, among other network performance considerations, each request generated by a handler function for a particular page may be bundled with one or more other requests prior to transmission to server 22 thereby potentially reducing the number of TCP handshakes required and eliminating the transmission of redundant data. In a particular embodiment, the developer of the corresponding application and handler function specifies (for example, by setting a bundle parameter to true (e.g., .setBundle(true)) in connection with registering the handler function with page rendering process 200), that the requests generated by the corresponding handler function may be bundled with other requests.

In such embodiments, each handler function generates a request and passes the request to proxy 230. Proxy 230 examines the corresponding bundler parameter and determines whether or not the request can be bundled at 410. If, at 410, it is determined that the request should not or cannot be bundled (e.g., .setBundle(false)), then the request may be transmitted to server 22 at 412 as an HTTP, HTTPS, or other appropriate request. On the other hand, if .setBundle is true, proxy 230 buffers the request at 414. By way of example, proxy 230 may start a timer upon receiving a first request from a handler function. Proxy 230 may then buffer the request and wait for subsequent requests from other handler functions (and buffer these as well) until the timer expires (e.g., after 10 milliseconds (ms)). Upon expiration of the timer, proxy 230 multiplexes or bundles the requests into a single bundled request at 416. By way of example, proxy 230 may bundle the requests into a single HTTP or HTTPS request and transmit this bundled request to server 22 at 418. In particular embodiments, server 22 includes a corresponding proxy 260 that demultiplexes or de-bundles the bundled request into its constituent requests and transmits these to each request's destination to be served.

In particular embodiments, in response to a request from a handler function, server 22 transmits incremental updates for the cached resource or resources to client 30 only if those resources that have changed since the timestamp transmitted with the request. That is, in contrast to conventional caching procedures in which a structured document is considered as a whole and in which any change in the structured document results in a flushing of the document from the client-side cache the request of the entire document, page rendering process 200 enables individual pagelets to request incremental updates via their corresponding handler functions without requiring that the whole page is re-requested. By way of example, if a resource has been changed or updated, the server 22 may send a new replacement resource or simply incremental data (or difference data indicating the changes to the underlying data) used to update a resource cached at the client 30. Upon reception of the updated resources (if any) from server 22, the handler function(s) insert(s) the updated resources into the page at 422. By way of example, this may involve inserting updated HTML or other content into a corresponding pagelet or other section of the rendered page or executing the updated scripts for use in rendering the page. Additionally, it may be desired to always request new resources for certain pagelets, such as, by way of example, pagelets that display advertisements such that each time a user returns to the same page a different advertisement is rendered.

However, in a particular embodiment, proxy 260 bundles the responses (e.g., the requested resources or updates) received for the individual requests into a single bundled HTTP or HTTPS request and then transmits the bundled request to proxy 230 for de-bundling by proxy 230 at 420 and subsequent distribution to the corresponding handler functions for use in rendering the correspond applications by page rendering process 200 via browser 210.

As illustrated in FIG. 4B, in particular embodiments, page rendering process 200 is additionally configured to record or store operations performed by a user on a web page. By way of example, a social networking site 20 may include various pagelets that include dialog boxes or other means to enter comments or other input, such as commenting on a photo displayed within the currently rendered web page or leaving or responding to a message on a wall for or from another user. A technical challenge to caching is that the cached version of the underlying web page is the version that does not include the comments or updates added by the user. Such an operation may be referred to as an in-page write and generally involves transmitting an HTTP Post request to the server 22 which then results in a write to a corresponding database and a resulting modification to a corresponding resource. Alternately, the in-page write may be embodied by an AJAX or other asynchronous request transmitted to server 22, where data (which may include data entered by the user and included in the request) may be returned in an AJAX response object. Write operations are therefore considered state-changing operations as they involve a change in state of the corresponding resource.

In particular embodiments, page rendering process 200 includes one or more application programming interfaces (such as an additional flag or parameter of the PageCacheRegister API discussed above) that allow applications in pagelets or other sections to indicate that state changing operations should be recorded. Such an indication causes page rendering process 200 to record state-changing operations, such as writes. By way of example, when an embedded script (such as an AJAX process) makes a request (such as a POST request) it registers a callback function to be called when a response to the request is received by browser 210. Page rendering process 200, in one embodiment, also supports APIs (e.g., set Replayable(true) that allow the embedded script to cause the response object to be stored. Page rendering process 200 may store the state-changing operation (in one embodiment, embodied as an AJAX response object) in association with the callback function registered by the embedded script within the corresponding data object stored for the pagelet on which the operation was performed. In this way, when the user navigates away from the page in which the operation was performed and later navigates back to the page in which the operation was performed, page rendering process 200 calls or executes the callback function which then re-executes the operation in the context of the cached page.

As illustrated in FIG. 4B, in response to a cache hit for a page in which a state-changing operation has been previously performed, page rendering process 200 accesses the corresponding data object and re-loads or re-executes the cached resources for the page as in step 404. However, the cached resources if rendered as they are cached would not reflect the state-changing operation without requesting the updated resource re-written by server 22 in response to the state-changing operation. In order to re-render the cached page to reflect the state-changing operation without transmitting a new request for the changed resource, page rendering process 200 at 405 uses the saved response object(s) to index into the handler function(s) that were initially registered in connection with the AJAX request and calls the callback function(s) corresponding to the re-written resource which then simulates or re-executes the state-changing operation on the corresponding cached resource such that the rendered page reflects the state-change. As FIG. 4B illustrates, page rendering process 200 may then call the corresponding on PageCacheRegister handler functions at 406 as described above, which may then generate requests for incremental updates to other features. In alternate embodiments, page rendering process 200 may not store callback functions to simulate state-changing operations on cached copies of resources; rather, the incremental updating procedure described above may be used to gather the updated resources.

In particular embodiments, page rendering process 200 is further configured to update a cached resource corresponding to a previously rendered page in response to a state-changing operation performed on a different subsequently rendered page. By way of example, with regard to a social networking system 20, a user's homepage may include a pagelet that presents the user with a notification that the user has one or more friend requests to approve or deny. The pagelet may include a link to another page in which the user can view each individual friend request and approve or deny the friend request. Such an operation may be referred to as a cross-page write and, in some implementations, may involve transmitting a HTTP POST request to the server 22 which then results in a write to a corresponding database or server 22, requiring modification to a corresponding resource rendered by the browser, in this case a resource that affects a feature on an earlier rendered homepage, if the user navigates back. For example, if the user then navigates back to his homepage and if the browser simply re-renders the cached resources stored for the homepage, the homepage will not reflect the state-changing operation(s) performed in connection with other pages. By way of example, the homepage may still show that the user has friend requests to approve or deny.

In response to a cross-page write operation such as that just described, an embedded AJAX script, for example, causes browser 210 to transmit an HTTP POST request to server 22 resulting in a write operation to a database accessed by server 22. In particular embodiments, process 250 is configured to transmit a response to client 30 in response to the POST request. In a particular example embodiment, the response includes a field that includes a list of cache messages indicating what information has been changed on or by the server 22. If the response indicates that the version of the resource at the database or server 22 has been changed, page rendering process 200 can determine that some or all of the cached page data is out of date and obsolete. In one embodiment, page rendering process 200 may then empty the page from the cache, as discussed more fully below. In an alternate embodiment in which the response from the server 22 indicates the specific resources that have been updated, page rendering process 200 can simply flush the corresponding obsolete cached resources from cache (rather than the whole page or even the whole pagelet) and use the incremental updating procedure described above to request the current versions of the resources. For example a pagelet, frame, or section of the page with its own URL, can specify, when it loads, a cache invalidation message in connection with the PageCacheRegister API that (if returned) means that the cached version of the pagelet should be flushed. When a response to an AJAX POST request is received, page rendering process 200 may access the response to determine whether it includes an invalidation messages. If so, page rendering process 200 invalidates all resources in the cache that are associated with the invalidation message(s) in the AJAX response. This operation ultimately causes the invalidated resources to be refreshed by access server 22.

As described in more detail below, the caching functionality described above can be utilized in connection with additional functionality that utilizes AJAX to retrieve resources for target URLs and simulates page transitions, as opposed to re-requesting and/or naively re-rendering requested structured documents. A particular implementation involving the use of AJAX, iframe, and/or other asynchronous techniques for requesting resources will now be described with reference to the flowcharts of FIGS. 5 and 6. Furthermore, additional details may be found in co-pending patent application Ser. No. 12/553,064 (Attorney Docket No. 079894.0106), entitled PAGE RENDERING FOR DYNAMIC WEB PAGES and filed on the same day as the present application, and which is hereby incorporated by reference herein. In some embodiments, page rendering process 200 is configured to execute the steps of FIGS. 5 and 6. In one example embodiment, the operations of FIGS. 5 and 6 can be embodied in a first code segment or script while the operations of FIGS. 4A and 4B maybe embodied in a second code segment or script. As described above, the behavior of page rendering process 200 may vary depending on various factors such as the particular browser the page rendering process 200 is executing within. By way of example, referring to FIG. 5, in the case that browser 210 is a version of Mozilla Firefox, page rendering process 200, and particularly the initialization function, may begin at 502 by attaching on-click event handlers to the links (e.g., hypertext links) within the web page. In particular embodiments, page rendering process 200 then attaches, at 504, other additional historical event handlers to the “back” and “forward” buttons in the client window rendered by browser 210. By way of example and not by way of limitation, a script or code based on the jQuery JavaScript library for dynamically attaching event handlers is provided below:

```
$(‘a’).click(function( ) {
  //’payload’ is a JSON encoded response from the server
  $.get(this.href, function(payload) {
    //Dynamically load ‘js’,‘css’ resources for this page.
    bootload(payload.bootload, function( ) {
      //Swap in the new page's content
      $(‘#content’).html(payload.html)
      //Execute the onloadRegister'ed js code
      Execute(payload.onload)
    });
  }
});
```

Generally, each event handler may be considered an asynchronous callback routine that handles a particular event, such as an on-click event (e.g., when a user clicks or otherwise selects a textual image or other link rendered or embedded within the web page) or a historical event (e.g., when a user clicks or otherwise selects the refresh, reload, back or forward button to navigate to a previously rendered web page). Page rendering process 200 may then register the historical event handlers with history manager 220 at 506. History manager 220 is generally a script (e.g., JavaScript) that also executes within browser 210 and records or stores various data relating to visited web pages. More particularly, history manager 220 stores, within a register or data store within client 30, URLs of web pages rendered by browser 210. By way of background, a URL generally specifies a location of a primary resource (e.g., a homepage). A fragment identifier (or hash) may be appended to the primary URL to identify the location of a secondary resource of a target web page. By way of example, a primary resource may be identified by the primary URL http://www.facebook.com/home.php while a target web page may be identified by appending a fragment identifier to the URL of the primary resource, such as http://www.facebook.com/home/php#/friends/?ref=tn. In other words, the target web page identified by the latter URL (and which includes the appended fragment identifier) may be considered a “child” web page and the web page corresponding to the former URL may be considered a “parent” web page. History managers in web browsers such as Mozilla Firefox and other like W3C compliant browsers are configured to record URLs of rendered web pages as well as fragment identifiers appended to the URLs. As will be described in more detail below, the event handlers serve to notify process 200 when the aforementioned events occur.

Now referring to the flowchart illustrated in FIG. 6, when a user desires to navigate to a target web page (whether cached or not cached corresponding to steps 408 and 403, respectively) from the currently rendered web page, one of the aforementioned events is passed to a corresponding event handler which performs one or more operations in response to the event as discussed below. In particular embodiments, and as described in more detail below, process 200 takes advantage of the shared content and other resources between web pages having the same primary URL as well as scripts already executed or executing to more efficiently request the needed resources for rendering the target web page.

In one example embodiment, upon receiving notification of an event via the corresponding event handler, page rendering process 200 effectively intercepts the request generated by browser 210 thereby preventing a conventional request from being transmitted to the server 22. As will be described in more detail below, this enables page rendering process 200 to formulate its own request for resources corresponding to the target page and eliminate the need for full page loading, thereby eliminating the transmitting of redundant data, certain page rendering operations (such as initializing one or more scripts) and improving network performance.

By way of example, assuming that the event is an on-click event corresponding to the clicking or selection of a link in the currently rendered web page, the event handler corresponding to the selected link notifies page rendering process 200 that the corresponding on-click event has occurred. However, in order to detect the selection of a back or forward button, history manager 220 periodically polls (e.g., every 200 milliseconds (ms)) a historical log of visited web pages to determine whether the most current URL recorded by history manager 220 matches the URL of the currently rendered web page. More specifically, in an example embodiment, history manager 220 transmits event notifications to notify page rendering process 200 of historical events by calling the corresponding historical event handlers registered by page rendering process 200. In other words, if a target web page is requested as described above, history manager 220 extracts the URL of the target web page. Assuming the target web page is a secondary or child web page and the currently rendered web page is either a primary or parent web page or another child web page, browser 210 still considers the target web page to effectively be the same page as the currently rendered web page given that they share the same primary URL; however, history manager 220 appends the fragment identifier corresponding to the target web page to the primary URL and records this as the most current URL in the browser history historical log. In this way, when history manager 220 polls the historical log after recording the fragment identifier associated with the target page, history manager 220 may compare the most current URL in the log with the URL corresponding to the currently rendered web page and, if the fragment identifiers are different (or if one of the two URLs does not include a fragment identifier), determine that the most current URL is different from the URL corresponding to the currently rendered web page thereby detecting that an event has occurred. History manager 220, via the corresponding historical event handler, then notifies page rendering process 200. Additionally, in particular embodiments, if the primary URL of the target web page is different from the primary URL of the currently rendered web page, page rendering process 200 does not intercept the request generated by browser 210, thus reverting to conventional default browser behavior and allowing browser 210 to request a full page load for the target web page.

After detecting that an event has occurred, page rendering process 200 then extracts the URL of the target web page (hereinafter referred to as the “target URL”) at 602 as illustrated in FIG. 6. By way of example, in this case of an on-click event corresponding to the selection of a link, page rendering process 200 may extract the target URL as well as other identifying information associated with the target web page from one or more link attributes embedded with the link. In the case of an event corresponding to the selection of a back or forward button, page rendering process 200 may extract the target URL and/or other identifying information from history manager 220.

In particular embodiments, page rendering process 200 may begin, at 604, a simulation of a typical page transition experience generally experienced when transitioning from one page to another (other alternate embodiments may not include a page transition simulation). By way of example, the page transition simulation may include “busy” indicators including one or more of the following: dynamically changing the shape, size, or position of the cursor such as, by way of example, generating a new cursor in the form of a rotating hourglass (implemented, for example, by changing or modifying the CSS properties for the body element of the web page); blanking out or whiting all or a portion of the client window (e.g., by setting the content areas of the page to empty or null values); rendering a “status” or “progress” bar in the client window (e.g., using iframe transport); and rendering a spinning or other dynamic icon next to the address bar rendered within the client window.

Page rendering process 200 then generates a request for the target web page at 606. By way of example, in order to generate the new request, page rendering process 200 may effectively translate a conventional request from browser 210 into one or more AJAX requests or calls. It should be noted, as described above, that AJAX refers generally to a variety of interrelated techniques used on the client side to asynchronously fetch content and, in some embodiments, may not necessarily involve JavaScripts or XML. However, in such embodiments, the new request may include one or more XMLHttpRequests for particular resources. In another particular embodiment, the new request may be implemented with a dynamically created invisible inline frame (iframe). More particularly, page rendering process 200 may assign or cause to be assigned the source attribute of the iframe to the target URL, causing a request identifying the target URL to be transmitted to server 22. The effect of this is that when browser 210 receives resources for the target web page in response to the new request, browser 210 will insert the resources in the response into the iframe. In particular embodiments, the iframe may call, for example, a JavaScript in the parent window that notifies page rendering process 200 of the arrival of the response. In still another alternate embodiment, page rendering process 200 may include a script tag in the new request. Page rendering process 200 then transmits the new request to server 22 at 608. Additionally, in some browser clients, page rendering process 200 creates an iframe to send the request that causes the browser status bar to display a busy or downloading status indicator, further simulating the page transition event.

In particular embodiments, process 250 includes an abstraction layer configured to determine whether an incoming request transmitted from client 30 is a request transmitted via page rendering process 200 or a conventional full page load request by browser 210. Furthermore, in some embodiments, page rendering process 200 may append or otherwise add a signature to the request transmitted via page rendering process 200. Such a signature enables process 250 to readily identify the request as a request transmitted via process 200. Additionally, the request may also include another parameter or signature that indicates the particular version of page rendering page rendering process 200 executing within browser 210 so that process 250 can better instruct server 22 as to how it should react or respond to the request. That is, assuming the request is a request from page rendering process 200, process 250 can instruct server 22 to bypass or skip some of the operations required when responding to conventional full page requests.

In response to the request from page rendering process 200, server 22 retrieves, from data store 24 or other servers or databases, one or more resources required to render the target web page at client 30. By way of example, the response from server 22 may include a JSON encoded data structure that includes the required resources, HTML content, and initialization code or scripts. However, rather than transmit all of the resources required to render the target web page, server 22 only retrieves and transmits those resources not previously transmitted to browser 210 in the user session as browser 210 has already cached portions of the content and resources required to render the target web page as these portions were already received and utilized by browser 210 in rendering one or more previous web pages. Process 200 receives the response, including the new resources required to render the target web page, from server 22 at 610 and dynamically downloads the new resources. In particular embodiments, page rendering process 200 facilitates, again using AJAX or other asynchronous techniques, the rendering of the new resources in the context of the previously rendered web page at 612, and ends the page transition simulation at 614. That is, in particular embodiments, page rendering process 200 resets or recycles content and other resources from previously rendered web pages and re-renders these recycled resources based on the new resources received in the response from server 22. In particular embodiments, page rendering process 200 causes browser 210 to re-render the portions of the target web page that have been previously downloaded or cached and then inserts the new resources received in the response at 610 to complete the rendering of the target web page. Particular embodiments reduce or eliminate the processing overhead associated with re-transmitting, re-downloading, and re-initializing commonly required code modules and other resources, such as JavaScript or CSS scripts or files, that execute within the context of the target web page and that have previously been downloaded and initiated when rendering previously rendered web pages thereby reducing bandwidth requirements and reducing the time required to render the target web page. In various embodiments, page rendering process 200 then waits for a next event.

The behavior of page rendering process 200 will now be described in the case that browser 210 is, for example, a version of Microsoft Windows Internet Explorer or the like. Unlike Mozilla Firefox, Microsoft Windows Internet Explorer does not record changes in fragment identifiers or hashes using history manager 220. In particular embodiments, page rendering process 200, and particularly the initialization function, may begin by inserting an inline frame (iframe) within a frame of the currently rendered web page. In particular embodiments, the inserted iframe is invisible to the user and includes a source property. When a target web page is selected, history manager 220 changes a source property or src attribute of the iframe to reflect the target web page. By way of example, the src attribute may be set to an index value which then maps to a particular URL stored in a table by history manager 220. Microsoft Windows Internet Explorer has the property that, if the source property of the iframe is changed, history manager 220 records a new entry in the browser history data store. By way of example, if a user then selected a back or forward button, browser 210 restores the previous value of the source property of the iframe corresponding to the desired web page.

In particular embodiments, a simple and static HTML page is embedded within the invisible inserted iframe. Information corresponding to the currently rendered web page is attached or appended to the query string corresponding to the HTML page. In particular embodiments, the embedded HTML page includes JavaScript that calls the parent page to notify page rendering process 200 when an event occurs. More particularly, the parent page may notify history manager 220 of the event and then history manager 220 may notify page rendering process 200 of the event. In particular embodiments, page rendering process 200 then proceeds as illustrated in FIG. 6 by extracting the target URL for the target web page at 602.

Although the present disclosure describes and illustrates particular steps of the methods or processes of FIGS. 3, 4, 5, and 6 as occurring in a particular order, the present disclosure contemplates any suitable steps of the methods of FIGS. 3, 4, 5, and 6 occurring in any suitable order. Moreover, although the present disclosure describes and illustrates particular components carrying out particular steps of the methods of FIGS. 3, 4, 5, and 6, the present disclosure contemplates any suitable combination of any suitable components carrying out any suitable steps of the methods of FIGS. 3, 4, 5, and 6.

The applications and/or processes described herein can be implemented as a series of computer-readable instructions, embodied or encoded on or within a tangible data storage medium, that when executed are operable to cause one or more processors to implement the operations described above. While the foregoing processes and mechanisms can be implemented by a wide variety of physical systems and in a wide variety of network and computing environments, the computing systems described below provide example computing system architectures of the server and client systems described above, for didactic, rather than limiting, purposes.

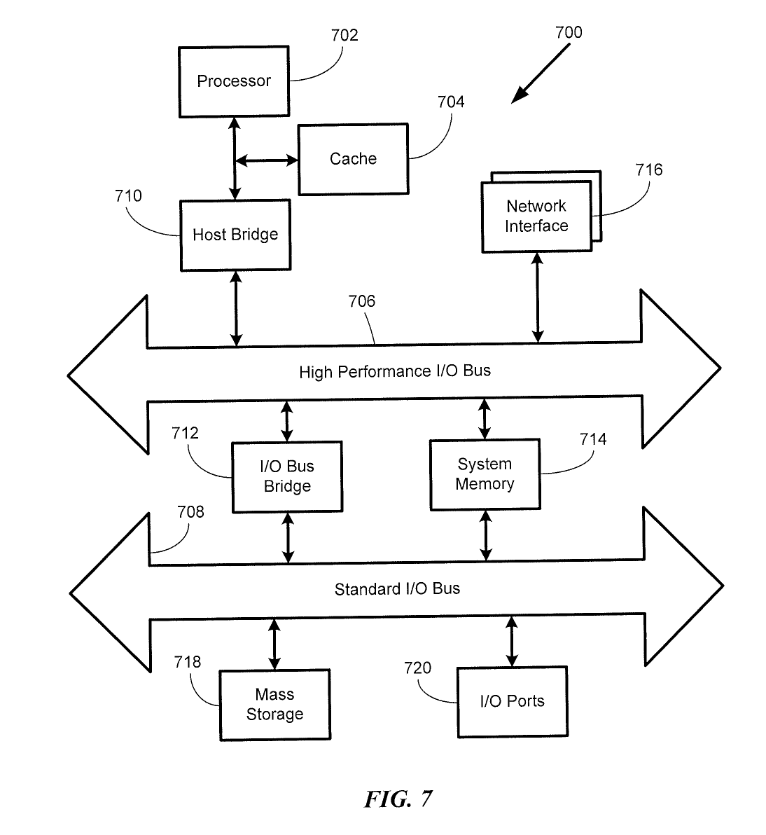

FIG. 7 illustrates an example computing system architecture, which may be used to implement a server 22a, 22b and/or a client device 30. In one embodiment, hardware system 700 comprises a processor 702, a cache memory 704, and one or more executable modules and drivers, stored on a tangible computer readable medium, directed to the functions described herein. Additionally, hardware system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network/communication interfaces 716 couple to bus 706. Hardware system 700 may further include video memory (not shown) and a display device coupled to the video memory. Mass storage 718, and I/O ports 720 couple to bus 708. Hardware system 700 may optionally include a keyboard and pointing device, and a display device (not shown) coupled to bus 708. Collectively, these elements are intended to represent a broad category of computer hardware systems, including but not limited to general purpose computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

The elements of hardware system 700 are described in greater detail below. In particular, network interface 716 provides communication between hardware system 700 and any of a wide range of networks, such as an Ethernet (e.g., IEEE 802.3) network, a backplane, etc. Mass storage 718 provides permanent storage for the data and programming instructions to perform the above-described functions implemented in the servers 22a, 22b, whereas system memory 714 (e.g., DRAM) provides temporary storage for the data and programming instructions when executed by processor 702. I/O ports 720 are one or more serial and/or parallel communication ports that provide communication between additional peripheral devices, which may be coupled to hardware system 700.

Hardware system 700 may include a variety of system architectures; and various components of hardware system 700 may be rearranged. For example, cache 704 may be on-chip with processor 702. Alternatively, cache 704 and processor 702 may be packed together as a “processor module,” with processor 702 being referred to as the “processor core.” Furthermore, certain embodiments of the present invention may not require nor include all of the above components. For example, the peripheral devices shown coupled to standard I/O bus 708 may couple to high performance I/O bus 706. In addition, in some embodiments, only a single bus may exist, with the components of hardware system 700 being coupled to the single bus. Furthermore, hardware system 700 may include additional components, such as additional processors, storage devices, or memories.

In one implementation, the operations of the embodiments described herein are implemented as a series of executable modules run by hardware system 700, individually or collectively in a distributed computing environment. In a particular embodiment, a set of software modules and/or drivers implements a network communications protocol stack, browsing and other computing functions, optimization processes, and the like. The foregoing functional modules may be realized by hardware, executable modules stored on a computer readable medium, or a combination of both. For example, the functional modules may comprise a plurality or series of instructions to be executed by a processor in a hardware system, such as processor 702. Initially, the series of instructions may be stored on a storage device, such as mass storage 718. However, the series of instructions can be tangibly stored on any suitable storage medium, such as a diskette, CD-ROM, ROM, EEPROM, etc. Furthermore, the series of instructions need not be stored locally, and could be received from a remote storage device, such as a server on a network, via network/communications interface 716. The instructions are copied from the storage device, such as mass storage 718, into memory 714 and then accessed and executed by processor 702.

An operating system manages and controls the operation of hardware system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft (r) Windows(r) operating systems, BSD operating systems, and the like. Of course, other implementations are possible. For example, the nickname generating functions described herein may be implemented in firmware or on an application specific integrated circuit.

Furthermore, the above-described elements and operations can be comprised of instructions that are stored on storage media. The instructions can be retrieved and executed by a processing system. Some examples of instructions are software, program code, and firmware. Some examples of storage media are memory devices, tape, disks, integrated circuits, and servers. The instructions are operational when executed by the processing system to direct the processing system to operate in accord with the invention. The term “processing system” refers to a single processing device or a group of inter-operational processing devices. Some examples of processing devices are integrated circuits and logic circuitry. Those skilled in the art are familiar with instructions, computers, and storage media.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. By way of example, while embodiments of the present invention have been described as operating in connection with a social networking website, the present invention can be used in connection with any communications facility that supports web applications. Furthermore, in some embodiments the term “web service” and “web site” may be used interchangeably and additionally may refer to a custom or generalized API on a device, such as a mobile device (e.g., cellular phone, smart phone, personal GPS, personal digital assistance, personal gaming device, etc.), that makes API calls directly to a server.

1. A method comprising:
in response to a determination that one or more resources related to a requested target structured document are stored in a cache:
accessing, by a first executable code segment embedded in a rendered structured document and executing within the context of a first client application, one or more resources related to the target structured document in the cache;
calling, by the first executable code segment, one or more handler functions associated with corresponding resources of the target structured document, each handler function operative to transmit requests to a remote server for updates to a respective resource; and
rendering, by the first executable code segment, content rendered by the first client application based at least in part on the one or more accessed resources in the cache and the updates retrieved by the one or more handler functions.

2. The method of claim 1, further comprising:
receiving, by a second executable code segment loaded in a second target structured document and executing within the context of the first client application, a request for the target structured document; and
determining whether one or more resources of the target structured document are maintained in the cache.

3. The method of claim 1, further comprising:
buffering one or more of the requests transmitted by one or more of the handler functions;
bundling the buffered requests into a multiplexed request; and
transmitting the multiplexed request to a remote host for processing.

4. The method of claim 1, further comprising:
presenting, by the first executable code segment, an application programming interface that allows one or more code modules associated with respective resources to register corresponding ones of the one or more handler functions to be called upon the cache hit in connection with the target structured document.

5. The method of claim 1, wherein the requests for updates each comprise a time stamp related to a time when the target structured document was last rendered by the first client application.

6. The method of claim 1, further comprising:
identifying one or more asynchronous response objects associated with the target structured document in the cache; and
causing, for each identified asynchronous response object, a handler function associated with such asynchronous response object to be re-executed to update content related to a resource of the one or more resources.

7. The method of claim 6, further comprising:
calling, by a corresponding handler function, a callback function that simulates a state-changing operation on one or more corresponding resources corresponding to the target structured document rendered by the first client application, the state-changing operation having been performed on a previously rendered version of the target structured document.

8. The method of claim 1, further comprising:
receiving, by the first executable code segment, a response from a remote host, the response comprising a field that includes a list of one or more cache messages that indicate resources related to the target structured document that have been changed at the remote host in response to a request sent in conjunction with a second structured document; and
deleting one or more resources at the cache related to the resources changed at the remote host based on the response.

9. An apparatus comprising
a memory;
one or more processors;
logic encoded in one or more storage media for execution and when executed operable to cause the one or more processors to:
receive a request for a first structured document from a first client application corresponding to a remote host; and
transmit a response to the remote host, wherein the response includes the first structured document, wherein the first structured document comprises a first executable code segment or an embedded reference to the first executable code segment, the first executable code segment executable within the context of the first structured document and the first client application, and comprising machine-readable instructions operative, when executed, to cause a processor to:
in response to a determination that one or more resources related to a requested target structured document are stored in a cache:
access one or more resources related to the target structured document in the cache;
call one or more handler functions associated with corresponding resources of the target structured document, each handler function operative to transmit requests to a remote server for updates to a respective resource; and
render content rendered by the first client application based at least in part on the one or more accessed resources in the cache and the updates retrieved by the one or more handler functions.

10. The apparatus of claim 9, wherein the response further comprises a second executable code segment executable within the context of the first structured document and the first client application, and comprising machine-readable instructions operative, when executed, to cause a processor to:
receive a request for the target structured document; and
determine whether one or more resources of the target structured document are maintained in the cache.

11. The apparatus of claim 9, wherein the response further comprises a second executable code segment executable within the context of the first structured document and the first client application, and comprising machine-readable instructions operative, when executed, to cause a processor to:
buffer one or more of the requests transmitted by one or more of the handler functions;
bundle the buffered requests into a multiplexed request; and
transmit the multiplexed request to a remote host for processing.

12. The apparatus of claim 9, wherein the first executable code segment further comprises machine-readable instructions operative, when executed, to cause a processor to:
present an application programming interface that allows one or more code modules associated with respective resources to register corresponding ones of the one or more handler functions to be called upon the cache hit in connection with the target structured document.

13. The apparatus of claim 9, wherein the requests for updates each comprise a time stamp corresponding to a time when the target structured document was last rendered by the first client application.

14. The apparatus of claim 9, wherein the first executable code segment further comprises machine-readable instructions operative, when executed, to cause a processor to:
identify one or more asynchronous response objects associated with the target structured document in the cache; and
cause, for each identified asynchronous response object, a handler function associated with such asynchronous response object to be re-executed to update content related to a resource of the one or more resources.

15. The apparatus of claim 14, wherein one or more of the handler functions are configured to call a corresponding callback function that simulates a state-changing operation on one or more corresponding resources related to the target structured document rendered by the first client application, the state-changing operation having been performed on a previously rendered version of the target structured document.

16. The apparatus of claim 9, wherein the first executable code segment further comprises machine-readable instructions operative, when executed, to cause a processor to:
receive a response from a remote host, the response comprising a field that includes a list of one or more cache messages that indicate resources related to the target structured document that have been changed at the remote host in response to a request sent in conjunction with a second structured document; and
delete one or more resources at the cache related to the resources changed at the remote host based on the response.

17. One or more computer-readable tangible storage media encoding software that is operable when executed to:
receive a request for a first structured document from a first client application corresponding to a remote host; and
transmit a response to the remote host, wherein the response includes the first structured document, wherein the first structured document comprises a first executable code segment or an embedded reference to the first executable code segment, the first executable code segment executable within the context of the first structured document and the first client application, and comprising machine-readable instructions operative, when executed, to cause a processor to:
in response to a determination that one or more resources related to a requested target structured document are stored in a cache:
access one or more resources related to the target structured document in the cache;
call one or more handler functions associated with corresponding resources of the target structured document, each handler function operative to transmit requests to a remote server for updates to a respective resource; and
render content rendered by the first client application based at least in part on the one or more accessed resources in the cache and the updates retrieved by the one or more handler functions.

18. The media of claim 17, wherein the response further comprises a second executable code segment executable within the context of the first structured document and the first client application, and comprising machine-readable instructions operative, when executed, to cause a processor to:
receive a request for the target structured document; and
determine whether one or more resources of the target structured document are maintained in the cache.

19. The media of claim 17, wherein the response further comprises a second executable code segment executable within the context of the first structured document and the first client application, and comprising machine-readable instructions operative, when executed, to cause a processor to:
buffer one or more of the requests transmitted by one or more of the handler functions;
bundle the buffered requests into a multiplexed request; and
transmit the multiplexed request to a remote host for processing.

20. The media of claim 17, wherein the first executable code segment further comprises machine-readable instructions operative, when executed, to cause a processor to:
present an application programming interface that allows one or more code modules associated with respective resources to register corresponding ones of the one or more handler functions to be called upon the cache hit in connection with the target structured document.

21. The media of claim 17, wherein the requests for updates each comprise a time stamp corresponding to a time when the target structured document was last rendered by the first client application.

22. The media of claim 17, wherein the first executable code segment further comprises machine-readable instructions operative, when executed, to cause a processor to:
identify one or more asynchronous response objects associated with the target structured document in the cache; and
cause, for each identified asynchronous response object, a handler function associated with such asynchronous response object to be re-executed to update content related to a resource of the one or more resources.

23. The media of claim 22, wherein one or more of the handler functions are configured to call a corresponding callback function that simulates a state-changing operation on one or more corresponding resources related to the target structured document rendered by the first client application, the state-changing operation having been performed on a previously rendered version of the target structured document.

24. The media of claim 17, wherein the first executable code segment further comprises machine-readable instructions operative, when executed, to cause a processor to:
receive a response from a remote host, the response comprising a field that includes a list of one or more cache messages that indicate resources related to the target structured document that have been changed at the remote host in response to a request sent in conjunction with a second structured document; and
delete one or more resources at the cache related to the resources changed at the remote host based on the response.
